(19) United States
(12) Patent Application Publication
(10) Pub. No.: US 2012/0079166 A1
(43) Pub. Date: Mar. 29, 2012

(54) ELECTRONIC DEVICE AND METHOD FOR INITIALIZING DATA STORAGE

(75) Inventors: ZHANG-YONG ZHENG, Shenzhen City (CN); BI-QING LUO, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/954,550

(22) Filed: Nov. 24, 2010

(30) Foreign Application Priority Data
Sep. 29, 2010 (CN) 201010296584.3

(51) Int. Cl. G06F 12/00; G06F 12/02

(52) U.S. Cl. 711/103; 711/156; 711/E12.001; 711/E12.008

(57) ABSTRACT

An electronic device for initializing a data storage is provided. The data storage has been accessed. The data storage includes a plurality blocks, which comprise some bad blocks. Each block comprising a block marking area for writing a block identifier. The block identifier is for marking whether the block is a bad block or a good block. After the data storage is accessed, a bad-block table for recording the block identifier of each block is stored at a predetermined location of the data storage. When initializing the data storage, the electronic device accesses the bad-block table from the predetermined location of the data storage, erases data stored on the data storage, obtains the block identifier of each block from the bad-block table; and writes the block identifier to the block marking area of each block.

### BACKGROUND

1. Technical Field

The present disclosure relates to an electronic device and method for initializing data storage.

2. Description of Related Art

Flash memory, such as Nand flash memory, is capable of being erased one block at a time. Generally, after manufacturing, the Nand flash memory may have some bad blocks. Before the Nand flash memory is delivered from the manufacturer, a block identifier is written to a predetermined location of each block to mark whether the block is a bad block. When the Nard flash memory is used by an OS for a first time, the block identifier of each block is read from the predetermined location of each block and is recorded to a bad-block table. The bad-block table is stored to a predetermined location of the Nand flash memory. When the Nand flash memory is used after the first time, the bad-block table is accessed to determine the bad blocks of the Nand flash memory. If another OS uses the Nand flash memory, because the other OS does not know the stored location of the bad-block table, the bad blocks of the Nand flash memory cannot be determined, thus the Nand flash memory cannot be used.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram of an electronic device to initialize a data storage in accordance with an exemplary embodiment.

FIG. 2 is a schematic diagram of a bad-block table stored in the data storage of FIG. 1.

FIG. 3 is a flowchart of a method for initializing the data storage in accordance with an exemplary embodiment.

### DETAILED DESCRIPTION

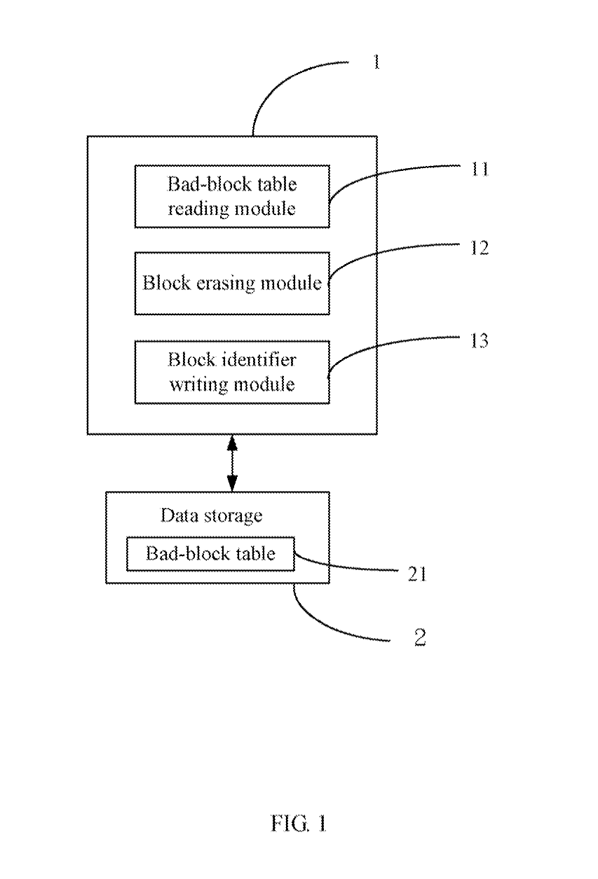

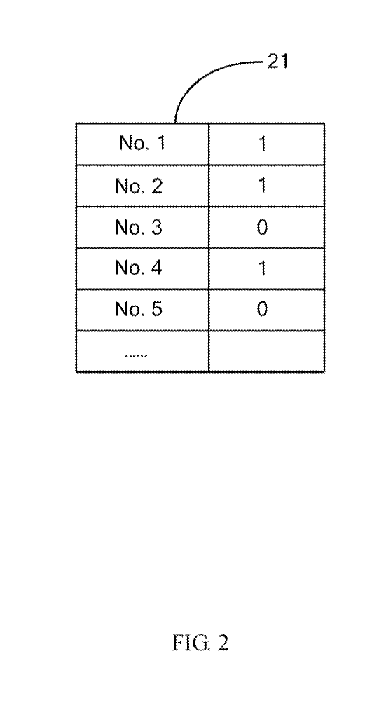

FIG. 1 is a schematic diagram of the electronic device 1 to initialize a data storage 2, in accordance with an exemplary embodiment. The data storage 2 can be taken as one component of the electronic device 1, and is installed inside the electronic device 1. The data storage 2 also can be taken as an independent device, and is connected to the electronic device 1 through an interface (not shown). The data storage 2, for example, such as a Nand flash memory, includes a number of blocks including some bad blocks, which cannot be used. Each block includes a block marking area for writing a block identifier of each block. The block identifier is for marking whether the block is a bad block or a good block. In this embodiment, the data storage 2 has been accessed by a first operating system. After the data storage 2 is accessed by the first operating system, the block identifiers in the block marking areas are erased. The data storage 2 stores a bad-block table 21 at a predetermined location. As shown in FIG. 2, the bad-block table 21 records the block identifier of each block of the data storage 2.

In this embodiment, as shown in FIG. 2, a bit “1” is set for representing the good blocks and a bit “0” is set for representing bad blocks.

In this embodiment, the first operating system is set up in electronic device 1. The electronic device 1 includes a bad-block table reading module 11, a block erasing module 12, and a block identifier writing module 13. The bad-block table reading module 11 accesses the bad-block table 21 from the predetermined location of the data storage 2. The block erasing module 12 is for erasing data stored in the data storage 2. After the data storage 2 is erased, the block identifier writing module 13 obtains the block identifier of each block from the bad-block table 21 and writes the block identifier to the block marking area of each block. Thus the data storage 2 is initialized and can be accessed by other OS.

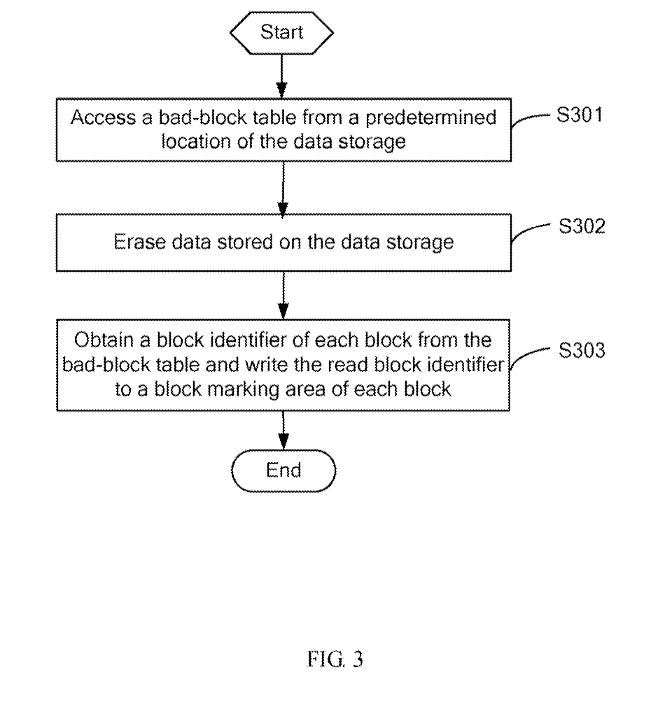

FIG. 3 is a flowchart of a method for initializing the data storage 2 in accordance with an exemplary embodiment. In step S301, the bad-block table reading module 11 accesses the bad-block table 21 from the predetermined location of the data storage 2.

In step S302, the block erasing module 12 erases data stored in the data storage 2.

In step S303, after data stored on the data storage 2 is erased, the block identifier writing module 13 obtains the block identifier of each block from the bad-block table 21 and writes the read block identifier to a block marking area of each block.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising a data storage, the data storage comprising a plurality of blocks, which comprise some bad blocks, each block comprising a block marking area for writing a block identifier for marking whether the block is a bad block or a good block, a bad-block table for recording the block identifier of each block being stored at a predetermined location of the data storage; the electronic device comprising:
a bad-block table reading module for accessing the bad-block table from the predetermined location of the data storage;
a block erasing module for erasing data stored on the data storage;
a block identifier writing module for obtaining the block identifier of each block from the bad-block table and writing the block identifier to the block marking area of each block.

2. The electronic device as described in claim 1, wherein the data storage is a Nand flash memory.

3. The electronic device as described in claim 1, wherein a block identifier “0” is set for representing bad blocks, and a block identifier “1” is set for representing good blocks.

4. An electronic device for initializing a data storage, the data storage, connected to the electronic device, comprising a plurality of blocks, which comprise some bad blocks, each block comprising a block marking area for writing a block identifier for marking whether the block is a bad block or a good block, a bad-block table for recording the block identifier of each block being stored at a predetermined location of the data storage; the electronic device comprising:
a bad-block table reading module for accessing the bad-block table from the predetermined location of the data storage;
a block erasing module for erasing data stored on the data storage;
a block identifier writing module for obtaining the block identifier of each block from the bad-block table and writing the block identifier to the block marking area of each block.

5. The electronic device as described in claim 4, wherein a block identifier “0” is set for representing bad blocks, and a block identifier “1” is set for representing good blocks.

6. An method for initializing a data storage, the data storage comprising a plurality of blocks, which comprise some bad blocks, each block comprising a block marking area for writing a block identifier for marking whether the block is a bad block or a good block, a bad-block table for recording the block identifier of each block being stored at a predetermined location of the data storage; the method comprising:
accessing the bad-block table from the predetermined location of the data storage;
erasing data stored on the data storage;
obtaining the block identifier of each block from the bad-block table and writing the block identifier to the block marking area of each block.

7. The method as described in claim 1, wherein the data storage is a Nand flash memory.

8. The method as described in claim 1, wherein a block identifier “0” is set for representing bad blocks, and a block identifier “1” is set for representing good blocks.
